(19) United States
(12) Patent Application Publication
(10) Pub. No.: US 2019/0389118 A1
(43) Pub. Date: Dec. 26, 2019

(54) Full Body Decoration of Blow Molded Tubes

(71) Applicant: Multi-Color Corporation, Batavia, OH (US)

(72) Inventor: Barron G. McKillip, Batavia, OH (US)

(21) Appl. No.: 16/448,455

(22) Filed: Jun. 21, 2019

Related U.S. Application Data
(60) Provisional application No. 62/687,854, filed on Jun. 21, 2018.

(51) Int. Cl. B29C 49/24; B65C 3/06; B29C 49/42; B29C 63/38

(52) U.S. Cl. CPC B29C 49/24; B65C 3/065; B29L 2031/712; B29C 63/38; B29C 49/4273

(57) ABSTRACT

A process for producing a tube, comprising forming a blow-molded article and removing a bottom portion of said blow-molded article. The blow-molded article includes (i) a head portion, and (ii) a tube portion integral with said head portion. The tube may be decorated, such as with a label.

### CROSS-REFERENCE TO RELATED APPLICATIONS

This application claims priority to and the benefit of the filing date of U.S. Provisional Patent Application Ser. No. 62/687,854, entitled “Full Body Decoration of Blow Molded Tubes,” filed Jun. 21, 2018, the disclosure of which is incorporated by reference herein in its entirety.

### FIELD OF THE INVENTION

The present invention relates to methods and systems for making and decorating tubes, and more specifically to making tubes via a blow molding process and decorating the tubes.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

As is well known in the art, current methods for manufacture and decoration (e.g., full body decoration) of plastic tubes generally includes the following steps: (1) extrusion, (2) heading, (3) decorating, and (4) capping.

The first phase of the manufacturing process, as described above, is extrusion. Referring to FIG. 1, in a typical process, resin or a mixture of resin and one or more other materials (e.g., a mixture of resin and color concentrate)—often in the form of beads or pellets—is placed into an extruder hopper 10. This material is then typically gravity fed from the hopper into a barrel 12 of the extruder 14, where it comes into contact with a screw 16. The screw 16 rotates, which feeds the resin (or mixture) 18 forward through the barrel 12. The barrel 12 is heated (via the use of a plurality of heaters 20 in the embodiment of FIG. 1), and the extruder is thus temperature controlled as the resin is fed through to ensure proper melt of the resin. Typically, the resin will melt gradually as it is pushed through the barrel 12. Additionally, or alternatively, heat may be contributed by the pressure and friction present inside the barrel.

At an end 22 of the barrel 12 distant the hopper 10, the now-molten plastic exits the screw 16 and barrel 12 by passing through a screen 24 that removes any contaminants. The molten plastic then passes through a die 26 or a set of dies (e.g., sizing dies) that are associated with the extruder (e.g., encapsulated within a right angle cross section attached to the extruder). The die 26 provides the profile for the article to be produced therefrom. In the formation of tubes, the die or dies may provide a sleeve 28. Once it has passed through the die, the extruded plastic elongated sleeve profile is cooled so that it can retain its shape. For example, the sleeve may be water-cooled. Once cooled, it is ready for cutting, and can be sliced to a given length by a rotating knife 30. This results in a plurality of sized sleeves (see 32).

Following extrusion, the heading portion of the manufacturing process is used to attach (or otherwise associate) a “head” portion 34 (see FIG. 2) to the sleeve 28 to form a tube 36. This heading process generally accomplished in one of three ways.

The most common method is a process of compression molding 38 a head portion onto the sleeve. In this process, the sleeve formed via extrusion is placed on a conveyor 40 that takes it to the heading operation. Here, the shoulder 42 of the head portion (i.e., the portion of the head proximal to the sleeve when attached) is bound to the sleeve 28 while, at the same time, a thread 44 may be formed. The head is then cooled, removed from the mold, and transferred into a pin conveyor.

Two other heading methods are used in the U.S. and are found extensively worldwide: (1) injection molding of the head to the sleeve, and (2) an additional compression molding method whereby a molten donut of resin material is dropped into the mold station instead of a hot melt strip or slug.

The head portion 34 (including shoulder 42) and the sleeve 28 are therefore two independent components, as can be seen in FIG. 2. The process of joining the two components together causes surface irregularities proximal to the junction of the head portion and sleeve (e.g., at the shoulder) as shown in FIGS. 3A-3C. In that regard, FIG. 3A is a photograph of a tube 36 manufactured using the extrusion process. As can be seen in FIG. 3A, the profile of the tube proximal the shoulder 42 (of the head portion 34) tapers away 46 from the straight edge of the ruler shown in the photograph. FIG. 3B shows a dimple 48 in the front center of the tube, beneath the edge of the shoulder 42 (the light reflection in the photograph shows a slight depression in the wall of the tube). And finally, FIG. 3C shows an air bubble 50 beneath the label 52 (once the decoration portion of the process has been completed), which is caused by the dimple 48 in the tube 36 shown in FIG. 3B.

In other words, the currently used processes for manufacture and decoration of such tubes are prone to irregularities in the tubes that result in mis-formed tubes, and lack of aesthetics in decoration.

In view of the drawbacks described above, improvement in the formation and decoration of articles, such as tubes, is needed.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

As described above, current methods of formation and decoration of articles, such as tubes, are inadequate.

And so, various aspects of the present invention overcome these and other drawbacks by providing a process for the formation and decoration of articles, such as tubes, that do not include the irregularities described above. To that end, one aspect of the present invention provides for decoration of a blow molded tube instead of the traditional tube formed by an extruded sleeve subsequently joined to a head portion (as described above). The process includes forming a blow molded container (e.g., bottle). This process thus forms a tube body with a head/shoulder already as an integral portion of the container. This eliminates the need to provide the head/shoulder as a separate component and engage in a separate heading process. Further, the use of a blow mold (as opposed to extrusion) can provide a container having a shape that does not suffer the irregularities in the body and/or surface of the tube (such as those shown in FIGS. 3A and 3B). Once the blow molded container has been produced, the bottom portion thereof (i.e., the end distant from the shoulder) may be removed (such as by being cut off) to provide the tube. This tube may also be decorated, such as via the use of a heat shrinkable pressure sensitive polyolefin label substrate. The decoration of the tube may occur following removal of the bottom portion thereof. Alternatively, the decoration of the tube may occur prior to removal of the bottom portion thereof.

Another aspect of the present invention includes a process for producing a decorated article. The method includes forming a blow-molded article that includes (i) a head portion, (ii) a body portion integral with said head portion, and (iii) a bottom surface. The method further includes applying a label to the blow-molded article, such that said label contacts and confronts at least a portion of the head portion, the body portion, and the bottom surface.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a schematic depicting a typical extrusion process for the formation of sleeves that are used to produce finished tubes.

FIG. 2 shows the separate head portion and sleeve components that are subsequently joined together following the extrusion of the sleeve (shown in FIG. 1).

FIG. 3A is a photograph of a tube manufactured using the extrusion and separate head joining process showing that the profile of the tube at the shoulder tapers away from the straight edge of the ruler that appears in the photograph.

FIG. 3B is a photograph of a tube manufactured using the extrusion and separate head joining process showing both sides of the tube and showing a dimple in the front center beneath the edge of the shoulder (where the light reflection shows a slight depression in the wall of the tube).

FIG. 3C is a photograph of the now-decorated tube of FIG. 3B showing a small air bubble beneath the label which is caused by the dimple in the bottle shown in FIG. 3B.

FIGS. 4A-4C are schematics depicting a blow molding process, such as that used in accordance with the principles of the present invention.

FIG. 4D shows the removal of a bottom portion of a tube from an article formed from the blow molding process shown in FIGS. 4A-4C followed by decoration of the tube, such as with a label.

FIG. 4E shows decoration (such as with a label) of an article formed from the blow molding process shown in FIGS. 4A-4C followed by removal of a bottom portion thereof.

FIG. 4F shows decoration (such as with a label) of an article formed from the blow molding process shown in FIGS. 4A-4C.

FIG. 4G shows a tube formed in accordance with principles of the present invention.

FIG. 5A is a photograph of a tube manufactured using a blow molding process and showing that the profile of the tube shoulder is perfectly straight when lined up with the straight edge of the ruler that appears in the photograph.

FIG. 5B is a photograph of a tube manufactured using a blow molding process showing both sides of the tube and showing that there is no depression present on the tube (as contrasted with the tube of FIG. 3B).

FIG. 5C is a photograph of the now-decorated tube of FIG. 5B showing no defects at the shoulder edge because the wall of the tube is dimple free.

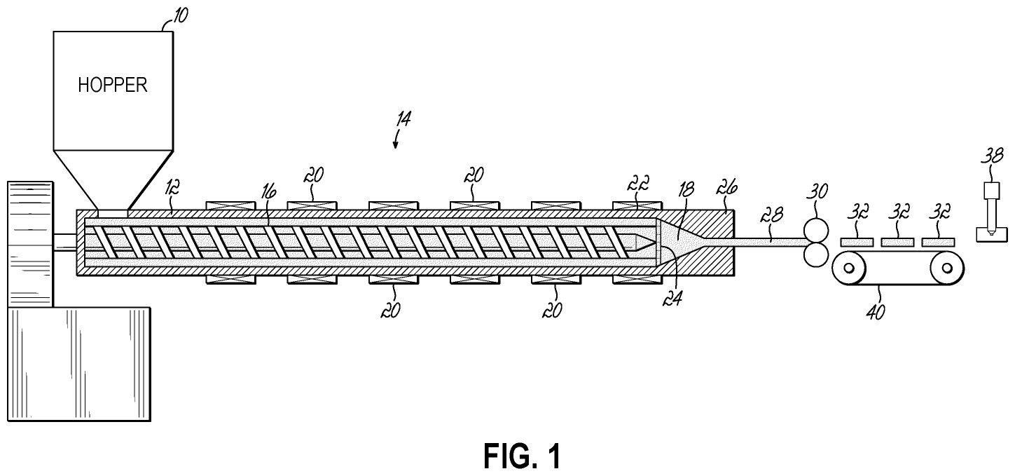

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, current methods of formation and decoration of articles, such as tubes, are inadequate.

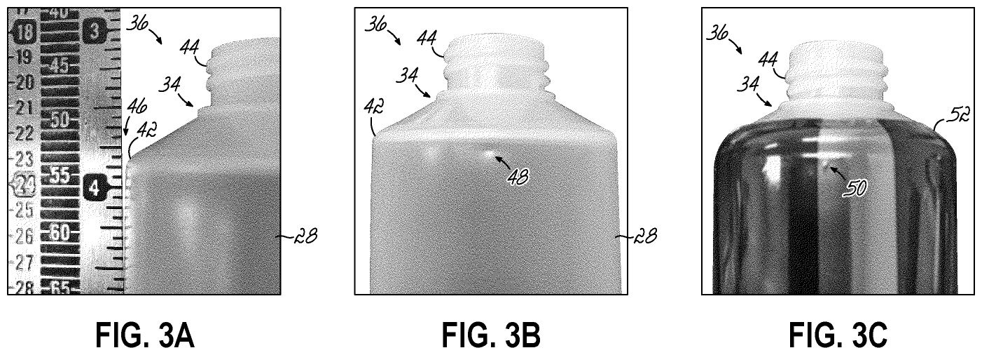

And so, various aspects of the present invention overcome these and other drawbacks by providing a process for the formation and decoration of articles, such as tubes, that do not include the irregularities described above. To that end, one aspect of the present invention provides for decoration of a blow molded tube instead of the traditional tube formed by an extruded sleeve subsequently joined to a head portion (as described above). The process includes forming a blow molded container (e.g., bottle). This process thus forms a tube body with a head/shoulder already as an integral portion of the container. This eliminates the need to provide the head/shoulder as a separate component and engage in a separate heading process. Further, the use of a blow mold (as opposed to extrusion) can provide a container having a shape that does not suffer the irregularities in the body and/or surface of the tube (such as those shown in FIGS. 3A and 3B). Once the blow molded container has been produced, the bottom portion thereof (i.e., the end distant from the shoulder) may be removed (such as by being cut off) to provide the tube. This tube may also be decorated, such as via the use of a heat shrinkable pressure sensitive polyolefin label substrate. The decoration of the tube may occur following removal of the bottom portion thereof. Alternatively, the decoration of the tube may occur prior to removal of the bottom portion thereof.

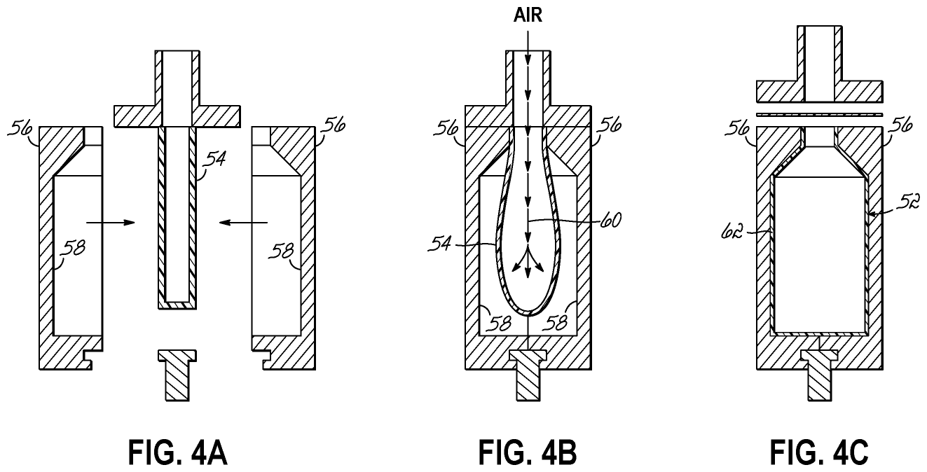

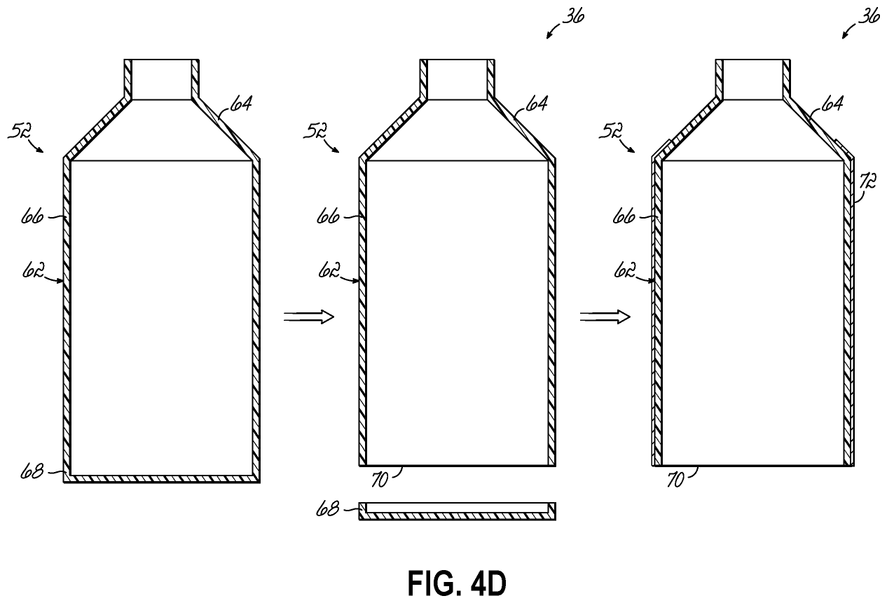

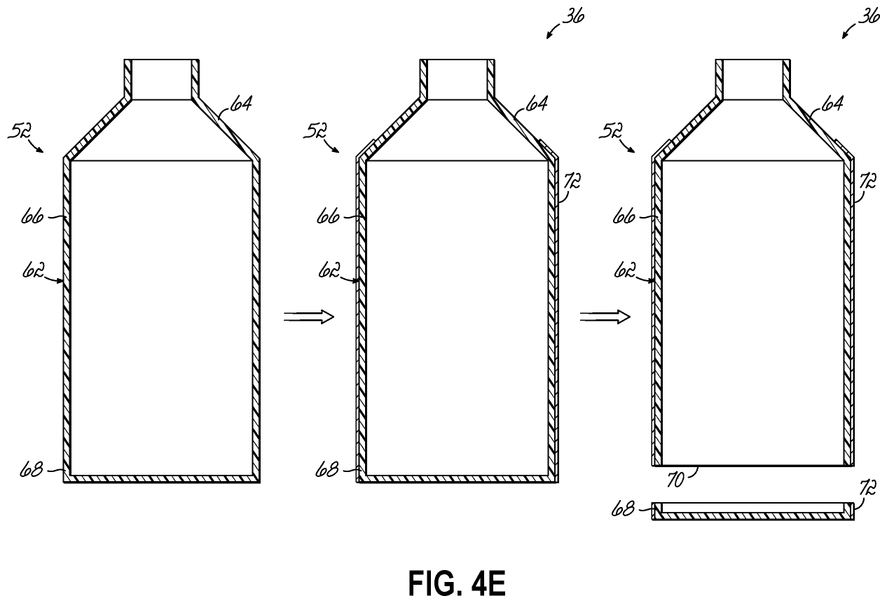

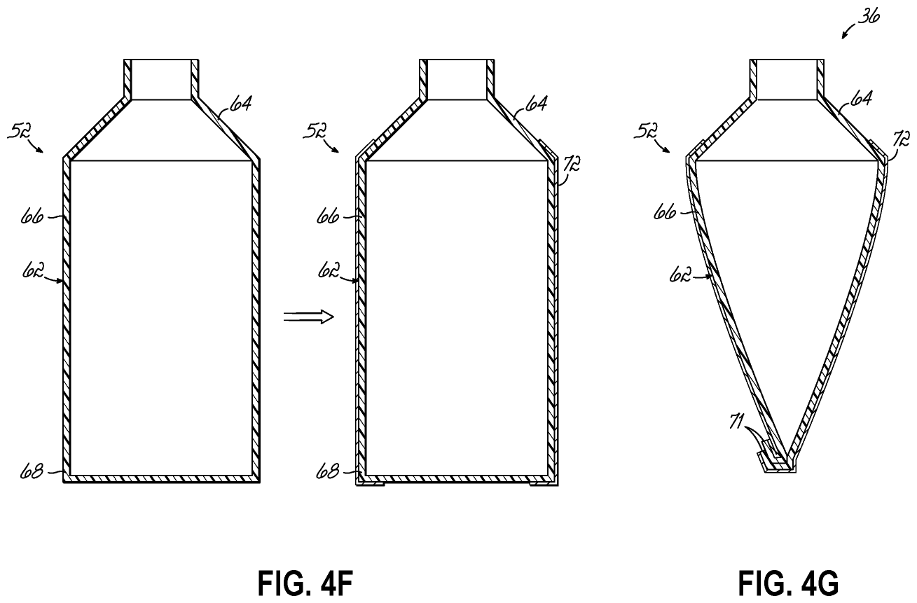

Referring now to FIGS. 4A-4C, a method of blow molding an article 52 is shown. In the blow molding process used herein, plastic is melted and formed into a hollow tube (referred to as a “parison” 54). This parison 54 is then placed within a mold 56 (typically made of metal). The interior 58 of the mold 56 is in the shape desired for the final product. Once the parison 54 is disposed within the mold 56, air is blown (see 60) into the parison 54, which inflates it into the shape of the mold—in the illustrated embodiment of FIGS. 4A-4C, the shape of a hollow bottle 62. Once the plastic has cooled sufficiently within the mold (such that it will retain its blow molded shape), the mold is opened and the blow molded article 52 (e.g., hollow bottle 62 in FIG. 4C) is removed.

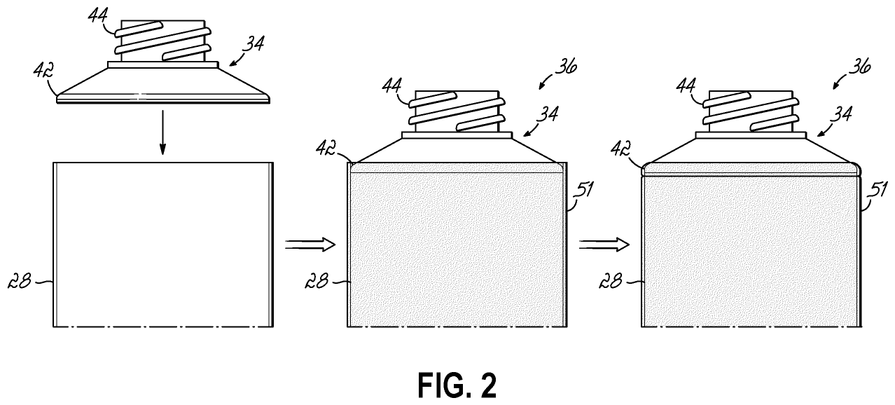

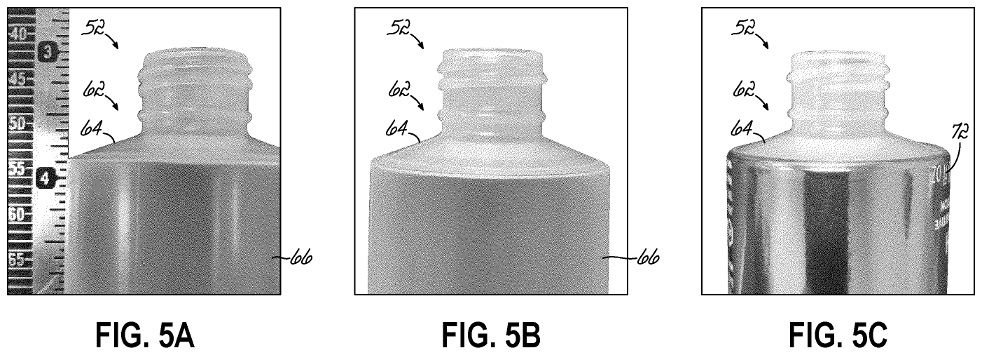

As can be seen from FIGS. 4A-4C (and referring also to FIG. 4D), once the article 52 (e.g., hollow bottle 62) is removed from the mold 56, the nature of the blow molding process has created an article that includes a head portion 64 integrally formed with the remainder of the body 66. This eliminates the need to provide a head portion 34 as a separate component and engage in a separate heading process (as is necessary with the typically used extrusion process—and as is shown in FIG. 2). Further, by eliminating the heading process, the present process thus avoids the defects that can be created due to the heading process. In other words, this is a single step process in which the head portion and body are created at the same time with the same resin. This results in a substantially perfect profile between the head portion 64 and the body 66 (see FIGS. 5A-5C, showing no taper of the body away from the ruler in FIG. 5A, no dimples or other irregularities in FIG. 5B, and no air bubbles in FIG. 5C).

Further, and referring now to FIG. 4D, once the blow molded article 52 (e.g., hollow container or bottle 62) has been produced, a bottom portion 68 thereof (i.e., an end distant from the head portion 64) may be removed (such as by being cut off by means well known to those of ordinary skill in the art) to provide the substantially finished tube 36. And, the top and bottom of the tube may be trimmed to any final desired dimensions. This trimming can also occur after a label has been applied to the tube. The open bottom end 70 of the tube may also then be closed off (such as by one or more of crimping, adhesive, heat, etc.—see FIG. 4G for a closed end 71 of a tube in accordance with principles of the present invention).

In this embodiment (and still referring to FIG. 4D), once a tube 36 has been formed via a blow molding process such as that described above, the next step is decoration of the tube. In one embodiment, this decoration process includes application of a label 72 (such as a heat shrinkable pressure sensitive label) to the tube 36—resulting in a decorated tube. A photograph of such an embodiment is shown in FIG. 5C. As the side profile and shoulder of the blow molded tube (as shown in FIGS. 5A and 5B) show no defects (due to the present process, as described above), the decorated tube of FIG. 5C also shows no defects at the shoulder edge, and thus, no aesthetically displeasing disruptions in the decoration of the tube. And, after a label has been applied (and shrunk) to the tube, the top and bottom of the tube may be trimmed to any final desired dimensions.

Another embodiment is shown in FIG. 4E. Referring now to that figure, once the blow molded article 52 (e.g., hollow container or bottle 62) has been produced, the next step is decoration of the article 52. In one embodiment, this decoration process includes application of a label 72 (such as a heat shrinkable pressure sensitive label) to the article 52—resulting in a decorated article.

In this embodiment (and still referring to FIG. 4E), once a decorated article 52 has been formed via a blow molding process followed by decoration, such as that described above, a bottom portion 68 thereof (i.e., an end distant from the head portion 64) may be removed (such as by being cut off by means well known to those of ordinary skill in the art) to provide a decorated tube 36. And, the top and bottom of the tube may be trimmed to any final desired dimensions. The open bottom end 70 of the tube may also then be closed off (such as by one or more of crimping, adhesive, heat, etc.—see FIG. 4G for a closed end 71 of a tube in accordance with principles of the present invention).

As a result of the above, various aspects of the invention provide decoration of the blow molded tube with a label that may cover 100% of the sleeve portion and extend over the shoulder to the tube as shown in FIG. 5C above.

Further, the process described herein reduces and eliminates the defects currently present on extruded tubes decorated in the same manner. Further still, the process described herein reduces the scrap percentage and simplifies the decoration process. This is because the defects associated with an extruded “two-piece” tube (i.e., separate sleeve and head portion) increases the difficulty in decorating the tube due to the defects present (e.g., dimples in the surface, and the possibility of air bubbles—such as proximal to the shoulder, as shown in FIG. 3B). Mis-decoration, due to defects in the tubes, causes an increase in downtime, and ongoing modifications to the labeling process. And, depending on the severity of the defects, this downtime and modifications can be substantial.

Finally, the finished product is more desirable as it gives the appearance of higher quality than that of an extruded tube.

Another aspect of the present invention includes a process for producing a decorated article. The method generally includes forming a blow-molded article that includes (i) a head portion, (ii) a body portion integral with said head portion, and (iii) a bottom surface. The method then further includes applying a label to the blow-molded article, such that said label contacts and confronts at least a portion of the head portion, the body portion, and the bottom surface.

More specifically, and referring now to FIG. 4F, once the blow molded article 52 (e.g., hollow container or bottle 62) has been produced by the process shown in FIGS. 4A-4C, the next step is decoration of the article 52. In one embodiment, this decoration process includes application of a label 72 (such as a heat shrinkable pressure sensitive label) to the article 52—resulting in a decorated article. When decorating the article 52, one may apply a label that results in substantially full body decoration of the article. In doing so, the label 72 is applied to the blow-molded article such that said label contacts and confronts at least a portion of the head portion 64, the body portion 66, and the bottom surface.

The embodiments of the present invention recited herein are intended to be merely exemplary and those skilled in the art will be able to make numerous variations and modifications to it without departing from the spirit of the present invention. Notwithstanding the above, certain variations and modifications, while producing less than optimal results, may still produce satisfactory results. All such variations and modifications are intended to be within the scope of the present invention as defined by the claims appended hereto.

What is claimed is:

1. A process for producing a tube, comprising:
forming a blow-molded article, said blow-molded article including (i) a head portion, and (ii) a tube portion integral with said head portion; and
removing a bottom portion of said blow-molded article.

2. The process of claim 1, further comprising applying a label to at least the tube portion.

3. The process of claim 2, wherein the label is chosen from a shrink sleeve label, a pressure sensitive label, and a heat transfer label.

4. The process of claim 3, wherein said label is a shrink sleeve label, and includes a heat shrinkable pressure sensitive polyolefin label substrate.

5. The process of claim 1, further comprising closing the open end of the tube portion following removal of the bottom portion of the blow-molded article.

6. The process of claim 2, wherein the label is applied to the tube portion and at least a portion of the head portion of the blow-molded article.

7. The process of claim 2, wherein applying the label to at least the tube portion occurs prior to removing the bottom portion of said blow-molded article.

8. The process of claim 7, further comprising closing the open end of the tube portion following removal of the bottom portion of the blow-molded article.

9. The process of claim 7, wherein the label is applied to the tube portion and at least a portion of the head portion of the blow-molded article.

10. A process for producing a decorated article, comprising:
forming a blow-molded article, said blow-molded article including (i) a head portion, (ii) a body portion integral with said head portion, and (iii) a bottom surface; and
applying a label to said blow-molded article, such that said label contacts and confronts at least a portion of said head portion, said body portion, and said bottom surface.

11. The process of claim 10, wherein the label is chosen from a shrink sleeve label, a pressure sensitive label, and a heat transfer label.

12. The process of claim 11, wherein said label is a shrink sleeve label, and includes a heat shrinkable pressure sensitive polyolefin label substrate.
